(19) United States
(12) Patent Application Publication
(10) Pub. No.: US 2021/0297406 A1
(43) Pub. Date: Sep. 23, 2021

(54) PEER-TO-PEER PRE-CHECK NETWORK

(71) Applicant: Wells Fargo Bank, N.A., San Francisco, CA (US)

(72) Inventors: Edward J. Landers, Lafayette, CA (US); Abhijit Rao, Irvine, CA (US); Byron G. Chun, Daly City, CA (US); Samuel B. Martin, San Francisco, CA (US); Michael H. Chang, Millbrae, CA (US); Traci H. Nguyen, San Francisco, CA (US); Douglas S. Pelton, Richmond, CA (US)

(21) Appl. No.: 15/284,947

(22) Filed: Oct. 4, 2016

(51) Int. Cl. H04L 29/06

(52) U.S. Cl. CPC H04L 63/0807; H04L 63/0876; H04L 63/0853

(57) ABSTRACT

A system includes at least one hardware processor in communication with a first computing device of a suspect party and a second computing device of an inquiring party, the suspect party being targeted for trust evaluation by the inquiring party, and a memory storing instructions that, when executed by the at least one hardware processor, cause the at least one hardware processor to perform operations. The operations include receiving, from the second computing device, a request to perform a trust evaluation of the suspect party, the request including a permission token, identifying the suspect party based on the permission token, generating a trust result for the suspect party based on financial data associated with the suspect party, the trust result indicating an assessed level of trustworthiness of the suspect party, and transmitting the trust result to the second computing device for display to the inquiring party.

### TECHNICAL FIELD

Embodiments described herein generally relate to peer-to-peer (P2P) networking and, for example and without limitation, to systems and methods for peer-to-peer sharing of evaluation data.

### BACKGROUND

In the course of daily life, transactions are performed between buyers and sellers of goods and services. In many transactions, sellers may sell their goods and services to buyers that are not previously known to them (e.g., via traditional in-store transactions or web-based transactions). As such, sellers may not know whether the buyers are trustworthy. In certain types of transactions, some sellers may not care whether the buyer is trustworthy. For example, in certain simple cash transactions for a good or service (e.g., cash purchase of a meal), the buyer's trustworthiness may not matter to the seller (e.g., they part ways after the transaction, the transaction complete, leaving no lingering involvement). In other transactions, however, the seller may wish to consider the trustworthiness of the buyer (or vice versa). For example, in some web-based marketplace transactions, the buyer and seller are strangers. The seller may be an unsophisticated seller (e.g., a private individual selling a single item), and both parties may wish to evaluate the trustworthiness of the other party before performing any of the obligations of a joint transaction.

### BRIEF DESCRIPTION OF THE SEVERAL VIEWS OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 illustrates an example networked environment including components of a peer-to-peer (P2P) evaluation system for providing a secure trust evaluation of a suspect party to an inquiring party;

FIG. 2 is a block diagram showing components within a P2P evaluation engine according to some embodiments;

FIG. 3 is a swim lane diagram of an example method for trust evaluation of the suspect party by the P2P evaluation system;

FIG. 4 is a swim lane diagram of an example method in which the P2P evaluation engine provides a mutual exchange of permission tokens between a first party and a second party;

FIG. 5 is a swim lane diagram of an example method for trust evaluation of the suspect party by the P2P evaluation system involving a third-party (3P) web server;

FIG. 6 illustrates an example computer-implemented method for providing a trust evaluation of the suspect party to the inquiring party; and

FIG. 7 is a block diagram illustrating a machine in the example form of a computer system, within which a set or sequence of instructions can be executed to cause the machine to perform any one of the methodologies discussed herein, according to an example embodiment.

### DETAILED DESCRIPTION

The systems and methods described herein, for example, describe a technical solution to permit buyers or sellers to electronically evaluate each other for trustworthiness (e.g., as a prelude to a business transaction or some other relationship or exchange). A peer-to-peer (P2P) evaluation system and P2P network are described herein. The P2P evaluation system provides a trustworthiness evaluation of a suspect party (e.g., a buyer or a seller) to an inquiring party (e.g., the other party in a two-party relationship, such as a business transaction) in a secure and permissioned electronic exchange between computing devices of the two parties.

In one example embodiment, the P2P network includes a P2P evaluation engine in communication with a computing device of the inquiring party and a computing device of the suspect party (e.g., smartphones, tablets, and so forth), The P2P evaluation engine accesses data associated with the suspect party that may include, for example, credit card data (e.g., current balances, credit limits, payment history), mortgage data (e.g., payment history), fraud scores, credit scores, banking data (e.g., hank products used, branch office visits, account balance, history), investment data (e.g., retirement data, portfolio balances), employment data (e.g., income level, length of employment, number of employers), gaming behavior data, and social network data. The previously described data is collectively referred to herein as “trust data sources,” Based on the data from one or more of the trusted data sources, the P2P evaluation engine generates a trust result for the suspect party. This trust result may be provided to the inquiring party, for example, as a numerical value (e.g., as a score between 1 and 10), a qualitative level (e.g., high, medium, low), or a grade (e.g., “A”, “B”, “C”, “D”, “F”). In some embodiments, this trust result will be valid for a specified duration such as 15 minutes, 2 hours, 3 days, and so on. The P2P evaluation engine may inform the inquiring party if there is a change in the suspect party's trust result (e.g., if the trust result degrades during the specified duration), The inquiring party may specify a set of metrics against which the trust value of the suspect party is to be generated. For example, Jill's trust value is “A” for <$100 transaction to be performed over 3 days, and it will change to trust value “C” for <$500 transaction over 1 day. The trust value may decay over time.

The P2P network may be used by the parties during, for example, a prospective business transaction, such as a two-party sale, where one of the parties wants to investigate the trustworthiness of the other. The trustworthiness evaluation is provided by the P2P network in a secure exchange. The secure exchange may protect the privacy of the suspect party, among other benefits. In an example embodiment, the P2P evaluation engine generates a temporary token (“permission token”) that may be used to identify the suspect party within the P2P network. This permission token provides security benefits by not exposing any identifying information of the suspect party to the inquiring party. Further, the permission token may include restrictions within the P2P network (e.g., time restrictions, or aspects of trust evaluation restrictions, or reference to other aspects of the trust evaluation, such as identifying a particular inquiring party).

In some embodiments, the P2P evaluation engine allows the suspect party to initiate a trustworthiness evaluation. For example, the suspect party may click a button on an e-commerce web site of the inquiring party that authorizes the inquiring party to request a trustworthiness evaluation of the suspect party, thereby generating and providing the permission token to the inquiring party. In other embodiments, the P2P evaluation engine allows the inquiring party to initiate a trustworthiness evaluation. For example, the inquiring party may transmit a request for a trustworthiness evaluation of the suspect party to the P2P evaluation engine. The P2P evaluation engine transmits an approval request to the suspect party to approve or deny providing a trustworthiness evaluation of the suspect party to the inquiring party. If the suspect party approves the evaluation, the P2P evaluation engine may generate and transmit the permission token to the suspect party (e.g., for passing to the inquiring party), or directly to the inquiring party (e.g., for subsequent use), or may initiate the trustworthiness evaluation without use of the permission token (e.g., providing the trust result, once approved by the suspect party).

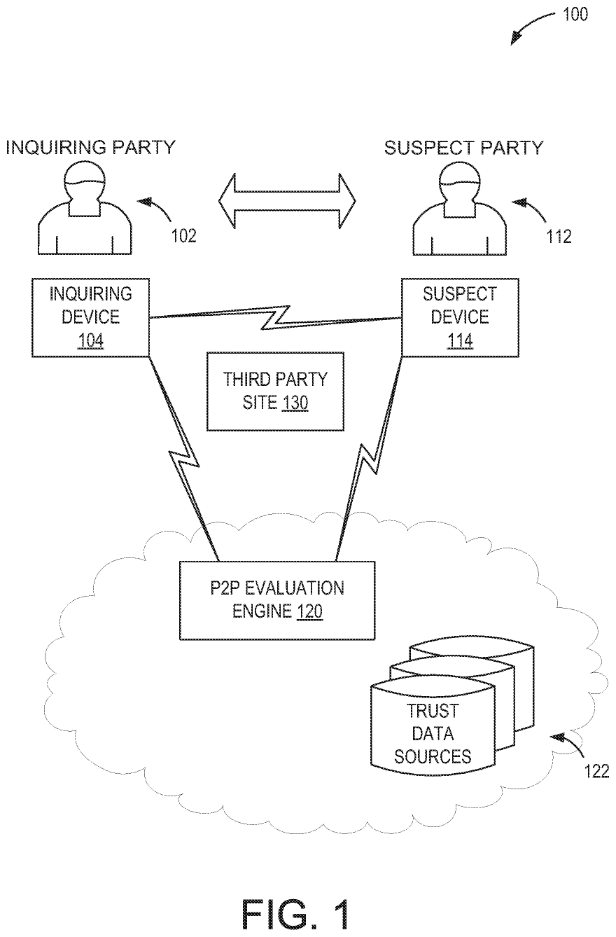

FIG. 1 illustrates an example networked environment including components of a P2P evaluation system 100 for providing secure trust evaluation of a suspect party 112 to an inquiring party 102. The P2P evaluation system 100 provides trust evaluation data associated with the suspect party 112 to the inquiring party 102. More specifically, a P2P evaluation engine 120 generates and provides a trust result associated with the suspect party 112 to the inquiring party 102 using trust data sources 122, which store data associated with the suspect party 112. The P2P evaluation engine 120 provides a computer-based trust evaluation of the suspect party 112 to the inquiring party 102, thereby allowing the inquiring party 102 to, for example, evaluate whether or not the inquiring party 102 wishes to participate in a business transaction with the suspect party 112.

The term “inquiring party,” as used herein, refers to a party that is requesting or otherwise receiving trustworthiness evaluation data from the P2P evaluation system 100 about another party (e.g., the suspect party). The term “suspect party,” as used herein, refers to a party that is the subject of the trustworthiness evaluation data provided to the inquiring party. The inquiring party and the suspect party may be parties involved in a transactional relationship of some sort. For example, in some embodiments, the inquiring party may be a merchant seller and the suspect party may be a buyer in a transaction for goods or services offered for sale by the merchant seller. While many of the example embodiments described herein depict a single inquiring party and a single suspect party, it should be understood that roles may be reciprocal. In other words, and for example, the suspect party 112 may also use the P2P evaluation system 100 to evaluate the trustworthiness of the inquiring party 102 (e.g., where the suspect party 112 would be an inquiring party, and the inquiring party 102 would be a suspect party).

In an example embodiment, the inquiring party 102 uses an inquiring device 104 and the suspect party 112 uses a suspect device 114 to interact with the P2P evaluation engine 120. The inquiring device 104 and the suspect device 114 are computing devices and may be, for example, personal computers (e.g., laptops, desktops), mobile devices (e.g., smartphones, tablets), or any other computing device that enables the systems and methods described herein. In some embodiments, the inquiring device 104 and the suspect device 114 may communicate with each other via near-field communication (NFC), Bluetooth, or other wireless communication methods. In some embodiments, one or more of the inquiring device 104 and the suspect device 114 may communicate with the P2P evaluation engine 120 via a shared computer network such as the Internet, and may use wireless networking methods (e.g., Wi-Fi, cellular network) to access the computer network.

In an example embodiment, the inquiring party 102 and the suspect party 112 are depicted as individuals. For example, the inquiring party 102 and the suspect party 112 may be an independent buyer and seller meeting via a classified advertisement system (e.g., Craigslist) and considering a two-party, sale for a used consumer product. In other embodiments, the inquiring party 102 may be business entities (e.g., merchant businesses, e-commerce web sites, and so forth). For example, the inquiring party 102 may be a business entity (e.g., a brick-and-mortar retailer, an online retailer, or another merchant selling products or services in commerce) and the suspect party 112 may be a consumer (e.g., making this a business-to-consumer (B2C) transaction). In some embodiments, the inquiring party 102 may be an individual consumer, and the suspect party 112 may be a business. In some embodiments, the P2P evaluation system 100 may provide a list of suspect parties 112 (e.g., several buyers or sellers) and the inquiring party 102 may select the suspect party 112 from the list. For example, the P2P evaluation system 100 may generate the list based on P2P scores, providing a list of the highest scoring suspect parties 112.

In an example embodiment, the P2P evaluation engine 120 performs a trust evaluation of the suspect party 112 and provides a trust result (not separately shown in FIG. 1) to the inquiring party 102. To perform the trust evaluation, the P2P evaluation engine 120 uses one or more trust data sources 122. The trust data sources 122 include data elements associated with the suspect party 112. In some embodiments, the trust data sources 122 includes financial information associated with the suspect party 112. For example, the trust data sources 122 may include bank card information (e.g., credit limits, payment history, debit card account total, length of time an account has been open, average balances on credit or debit cards, velocity of transactions), banking history (e.g., length of time with the bank, how many bank products used, number of times overdrawn or compromised, account balances, frequency of branch visits, how long since last branch visit), employment information (e.g., how long employed, employer, yearly salary, how many short-term jobs), gaming behavior information (e.g., type of games played, conduct within games, propensity to cheat), computing device information (e.g., device security scores, device characteristics, frequency of password changes, authentication preferences, originating domain, geolocation of device, geolocation of device relative to known list of frequented places or regions), or fraud scores (e.g., commercial credit scores, or other proprietary fraud scores). Such data provides, for example, significant metrics of trustworthiness as may be related to financial transactions.

In some embodiments, one or more of the inquiring device 104, the suspect device 114, and the P2P evaluation engine 120 may communicate with a third-party server 130. The third-party server 130 may be, for example, an online e-commerce site (e.g., Amazon.com), an online classified advertisements site (e.g., Craigslist), a merchant site (e.g., BMW.com), or an online auction site (e.g., eBay). In some embodiments, the third-party server 130 may be involved in performing aspects of the trust evaluation of the suspect party 112.

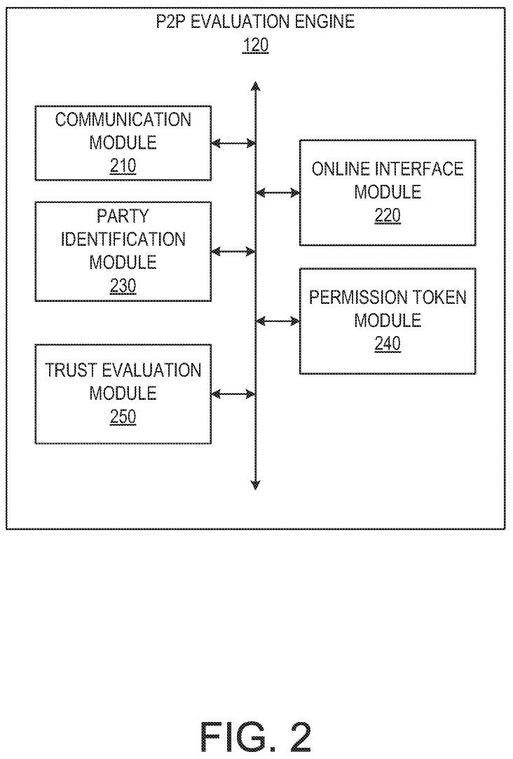

FIG. 2 is a block diagram showing components within the P2P evaluation engine 120, according to some embodiments. The P2P evaluation engine 120 may be hosted on dedicated or shared server machines (not shown) that are communicatively coupled to facilitate communications between the server machines. The components themselves may be communicatively coupled to each other and to various data sources, so as to allow information to be passed among the components or so as to allow the components to share and access common data. Furthermore, the components may access one or more databases (e.g., trust data sources 122) via database servers (not separately shown). In the example embodiment, the P2P evaluation engine 120 includes a communication module 210, an online interface module 220, a party identification module 230, a permission token module 240, and a trust evaluation module 250.

The communication module 210, in an example embodiment, provides network communication functionality between the P2P evaluation engine 120 and other computing devices, such as the inquiring device 104, the suspect device 114, and the third-party server 130. In some embodiments, the communication module 210 facilitates communication over the Internet or other Internet. Protocol (IP) based networks (e.g., IEEE 802 standards). In some embodiments, the communication module 210 facilitates communication to devices over cellular networks (e.g., to smartphone or tablet devices over a 3G/4G network). In other embodiments, the communication module 210 allows the P2P evaluation engine 120 to communicate over both IEEE 802 standard-based network and a cellular network at the same time (e.g., connects to inquiring device 104 over the cellular network and connects to third-party websites over the 802 network. The online interface module 220 provides front-end functionality to users such as the inquiring party 102 and the suspect party 112, or to other content providers such as the third-party server 130. This front-end functionality may include application (app) interfaces (e.g., mobile apps), web-based interfaces (e.g., hypertext transfer protocol (HTTP) content, buttons, and so forth), REST API, conversational UX interfaces, or graphical user interfaces (GUIs).

The party identification module 230, in an example embodiment, identifies and tracks one or more parties associated with a particular trust evaluation. For example, during the life of a permission token (described in more detail below), the party identification module 230 tracks information such as, for example, which party generated that permission token, which party submitted that permission token during a trust evaluation request, and so forth. The P2P evaluation system 100 may include one or more user identification systems (not separately depicted) within which users such as the inquiring party 102 and the suspect party 112 may have unique user identifiers (Ms). The party identification module 230 resolves which of those parties (e.g., within the user identification systems) is involved with a trust evaluation, and may protect such identity from others.

The permission token module 240, in an example embodiment, provides functionality associated with permission tokens. In some embodiments, the permission tokens may be software tokens used to authorize access to protected data. For example, the permission token module 240 may generate permission tokens, including generating unique identifiers associated with the permission tokens, associating other information with the permission tokens, storing the permission tokens, and tracking and resolving the validity of the permission tokens. The trust evaluation module 250 provides functionality associated with providing a trust evaluation of parties such as the suspect party 112 or the inquiring party 102. For example, the trust evaluation module 250 may communicate with the trust data sources 122 to access trust data associated with the suspect party 112, compute trust scores for the suspect party 112, generate a trust result for the suspect party 112, and monitor changes in the trust scores or trust results for the lifetime of the trust evaluation.

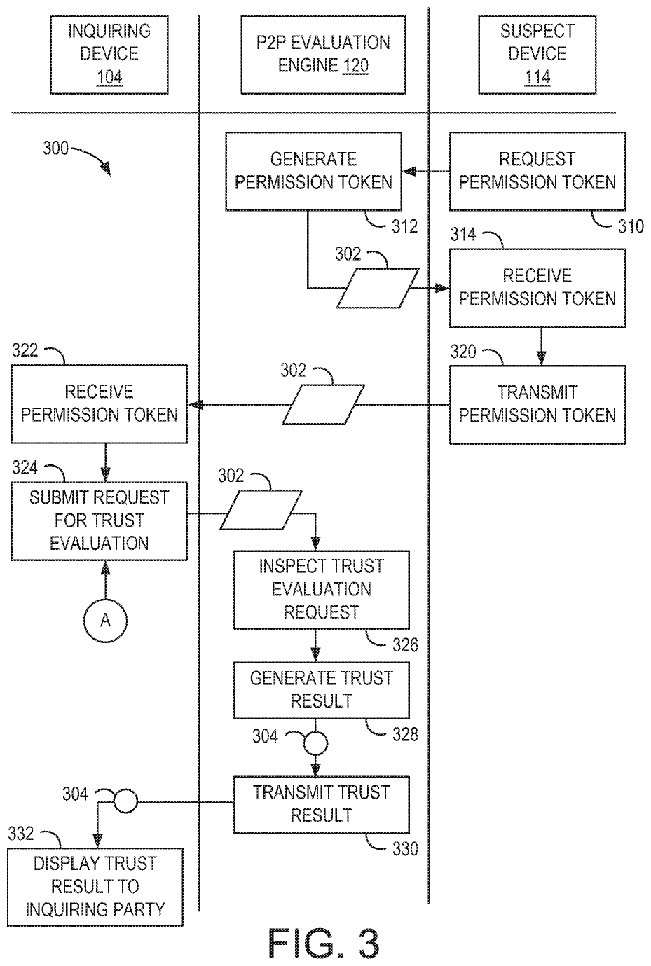

FIG. 3 is a swim lane diagram of an example method 300 for trust evaluation of the suspect party 112 by the P2P evaluation system 100. For example, the inquiring party 102 may be selling a used automobile via an online classified advertisement website, and the suspect party 112 may be a prospective buyer interested in purchasing the automobile. In the example shown in FIG. 3, the suspect party 112 initiates the trust evaluation of themselves. The suspect party 112 begins the trust evaluation by initiating a request for a temporary permission token from the P2P evaluation engine 120 at operation 310. In other embodiments, the inquiring party 102 initiates the trust evaluation of the suspect party 112 (e.g., the inquiring device 104 sending a request to the suspect device 114, thereby leading to operation 310).

At operation 312, the P2P evaluation engine 120 generates a permission token 302. In an example embodiment, the permission token 302 includes a unique identifier associated with this particular request from the suspect device 114. In some embodiments, the unique identifier may be a unique random number, or a unique sequence number or code. The P2P evaluation engine 120 identifies the suspect party 112 based on the request, and associates the suspect party 112 with the permission token 302. For example, the suspect party 112 or the suspect device 114 may have a unique user identifier (IL)) within the P2P evaluation system 100, and the P2P evaluation engine 120 may associate the permission token 302 with the user ID of the suspect party 112. As such, the permission token 302 does not directly identify the suspect party 112. In other words, while the permission token 302 may be shared with others, the user ID of the suspect party 112 remains protected.

At operation 314, the P2P evaluation engine 120 transmits the permission token 302 back to the suspect device 114. As such, operations 310-314 stage the permission token 302 on the suspect device 114 for later use. Accordingly, the request at operation 310 represents approval by the suspect party 112 to perform a trustworthiness evaluation of the suspect party 112 for whoever later submits the permission token 302 generated at operation 312.

In some embodiments, the permission token 302 may also include a trust result duration. The trust result duration identifies for how long the trust result associated with the permission token 302 is valid. For example, the trust result may only be valid for a pre-determined period of time (e.g., system default, or user-specified). In other embodiments, the trust result duration may be stored on the P2P evaluation engine 120 and enforced, but may not be shared via the permission token 302. In some embodiments, the P2P evaluation engine 120 may provide an API call for requesting the trust result or the trust result duration associated with the permission token 302 (e.g., GetTrustValue(permission_token), GetTrustValueDuration(permission_token).

At operation 320, the suspect party 112 transmits the permission token 302 to the inquiring party 102, For example, the suspect party 112 may use a client app on the suspect device 114 to identify the inquiring device 104 of the inquiring party 102. In some embodiments, the suspect device 114 and the inquiring device 104 communicate via a proximity-based (e.g., short-ranged) communication technology such as NFC or Bluetooth to exchange the permission token 302, or via a software-based communication technology. For example, the client app may scan and display nearby devices, from which the suspect party 112 identifies the inquiring device 104, or the inquiring device 104 may transmit a request for the permission token 302 to the suspect party 112, to which the suspect party 112 may respond. In other embodiments, the permission token 302 may be texted or emailed to the inquiring party 102. In some embodiments, the permission token 302 may be embodied within a QR code. At operation 322, the inquiring device 104 receives the permission token 302.

At operation 324, the inquiring device 104 submits a request for a trust evaluation to the P2P evaluation engine 120. The request includes the permission token 302. At operation 326, the P2P evaluation engine 120 receives the request and the permission token 302 and inspects the request. More specifically, the P2P evaluation engine 120 uses the permission token 302 to identify the suspect party 112 and ensure that the suspect party 112 has permissioned this trust evaluation. For example, the P2P evaluation engine 120 uses the unique identifier from the permission token 302 to identify the unique user ID of the suspect party 112. If the permission token 302 is not valid (e.g., if the unique identifier is not found), then the request may be rejected.

In some embodiments, the P2P evaluation engine 120 may identify an expiration time, or a valid timeframe, for the permission token 302. An expiration time indicates a time after which the permission token 302 is no longer valid. A valid timeframe indicates a time within which the permission token 302 is valid, and a timeframe outside of which the permission token 302 is not valid. For example, the permission token 302 may have an expiration time set to a predetermined amount of time from its creation (e.g., 15 minutes from the time of operation 312). In some embodiments, the expiration time may be set to a default amount of time (e.g., 1 hour). In other embodiments, the expiration time or the valid timeframe may be configured by the suspect party 112. As such, at operation 326, if the permission token 302 is no longer valid (e.g., expired), then the request may be rejected.

In some embodiments, the P2P evaluation engine 120 may identify a limited number of uses for the permission token 302. For example, the permission token 302 may be created for a one-time use. The P2P evaluation engine 120 may maintain a use counter associated with the permission token 302 and, upon each receipt of a request for trust evaluation having that permission token 302, may decrement the counter. Upon the counter reaching zero, the P2P evaluation engine 120 may expire or delete the permission token 302, or otherwise reject any request having the permission token 302.

In some embodiments, the permission token may be a hash of the bundle of data, a cryptographic nonce value, and a current time. The bundle of data may include the expiration time, details of the inquiring party, and details of the suspect party. The P2P evaluation engine 120 may maintain a table that maps each permission token to the bundle of data.

If the permission token 302 is valid and the suspect party 112 is identified, then the P2P evaluation engine 120 performs a trust evaluation of the suspect party 112 and generates a trust result 304 at operation 328. Once generated, the trust result 304 is transmitted to the inquiring device 104 at operation 330 and displayed to the inquiring party 102 at operation 332.

In some embodiments, the trust result 304 represents a composite view of the financial character (e.g., trustworthiness) of the suspect party 112. As such, it may be desirable to protect the privacy of the trust result 304 and/or the permission token 302. Providing the permission token 302 to the suspect device 114 enhances security by, for example, allowing the suspect party 112 to control access to the permission token 302. Transmission of the permission token 302 based on a proximity of the suspect device 114 to the inquiring device 104 enhances the security of the permission token 302 (e.g., making the permission token 302 more assured to end up at the intended device). When the permission token 302 is presented with the request for trust evaluation before providing the trust result 304, the P2P evaluation engine 120 protects who can request the trust result 304 (e.g., the party to whom the permission token 302 was given by the suspect party 112). Generating the permission token 302 based on the request of the suspect party 112 allows the suspect party 112 to be the gatekeeper of their trust result 304 (e.g., the permission token 302 acts as a permission for the bearer to access the trust result 304). Further, replay attacks using the permission tokens may be mitigated using nonce and timestamping, with the P2P evaluation engine 120 checking the permission token by recalculating it and checking the table.

In some embodiments, the inquiring party 102 may similarly provide permission to the suspect party 112 to submit a request for trust evaluation of the inquiring party 102. In other words, the inquiring party 102 may be a suspect party, and the suspect party 112 may be an inquiring party.

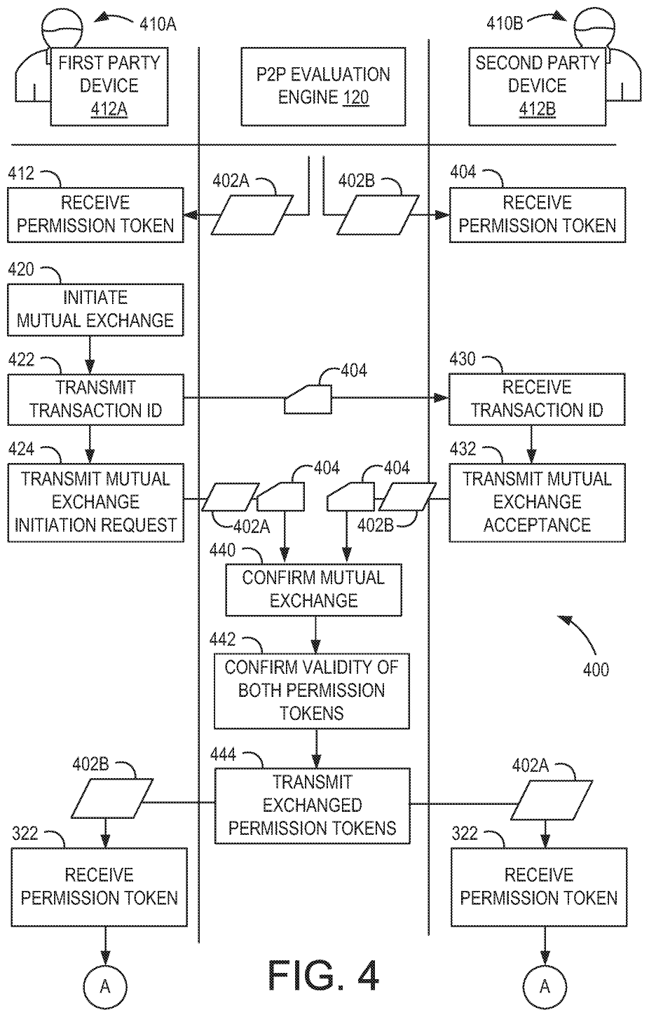

FIG. 4 is a swim lane diagram of an example method 400 in which the P2P evaluation engine 120 provides a mutual exchange of permission tokens between a first party 410A and a second party 410B (collectively, “the parties 410”). In some situations, both parties 410 may wish to request and acquire trust evaluations of each other e.g., prior to entering into a transaction). In the example embodiment, the first party 410A utilizes a first-party device 412A and the second party 410B utilizes a second-party device 412B. The first party 410A and the second party 410B may be similar to the inquiring party 102 and the suspect party 112, and the first-party device 412A and the second-party device 412B may be similar to the inquiring device 104 or the suspect device 114.

In an example embodiment, the P2P evaluation system 100 treats each party 410A, 410B as both an inquiring party 102 and a suspect party 112. More specifically, each party 410A, 410B requests and receives their own permission token 402A, 402B (collectively, “permission tokens 402”) from the P2P evaluation engine 120 at operations 404 and 412, respectively. The permission tokens 402 may be similar to the permission token 302. Operations 404 and 412 may be similar to operation 314, and each may be preceded by request and permission token generation operations similar to operations 310 and 312, as described above (not shown in FIG. 4 for simplicity). In other words, the first party 410A separately requests and receives the permission token 402A from the P2P evaluation engine 120, and the second party 410B separately requests and receives the permission token 402B from the P2P evaluation engine 120.

A mutual exchange is then initiated at operation 420. In an example embodiment, the mutual exchange is initiated by the first-party device 412A, thereby permissioning the sharing of the permission token 402A with the second party 410B if the mutual exchange is successful. In another embodiment, the second-party device 412B may similarly initiate the mutual exchange. The first-party device 412A generates and transmits a transaction ID 404 to the second-party device 412B (e.g., via short range communication) at operation 422. The transaction ID 404 may be, for example, a random number, a timestamp, or another pseudo-random number. The transaction ID 404 is used by the P2P evaluation engine 120 to link the first party 410A with the second party 410B in this particular mutual exchange, as described in more detail below. At operation 424, the first-party device 412A transmits a mutual exchange initiation request message to the P2P evaluation engine 120. This request includes the transaction ID 404, and may include the permission token 402A of the first party 410A or other identification of the first party 410A (e.g., such that the P2P evaluation engine 120 may identify the permission token 402A within its own memory).

At operation 430, in an example embodiment, the second-party device 412B receives the transaction ID 404 from the first-party device 412A. The second party 4109 is presented with an offer to join the mutual exchange with the first party 410A and if the offer is accepted by the second party 410B, the second-party device 412B transmits a mutual exchange acceptance message to the P2P evaluation engine 120 at operation 432. The acceptance message includes the transaction ID 404, and may include the permission token 402B of the second party 410B or other identification of the second party 410B (e.g., such that the P2P evaluation engine 120 may identify the permission token 402B within its own memory).

At operation 440, the P2P evaluation engine 120 receives both the mutual exchange initiation request (e.g., with the permission token 402A and the transaction ID 404) and the mutual exchange acceptance message (e.g., with the permission token 402B and the same transaction ID 404). The P2P evaluation engine 120 matches up the initiation request with the acceptance message based on the shared transaction IL) 404, and thus confirms acceptance of the mutual exchange by both parties 410. If no initiation request or acceptance message is received, then the mutual exchange is cancelled.

At operation 442, in an example embodiment, the P2P evaluation engine 120 confirms the validity of both permission tokens 402A, 402B (e.g., as described above with respect to FIG. 3). If either or both of the permission tokens 402A, 402B are found to be invalid, then the mutual exchange is cancelled. If both permission tokens 402A, 402B are valid, then the P2P evaluation engine 120 transmits exchanged permission tokens 402 to the other party 410 at operation 444. More specifically, the P2P evaluation engine 120 transmits the permission token 402B of the second party 410B to the first-party device 412A and transmits the permission token 402A of the first party 410A to the second-party device 412B. Each device 412 then receives the permission token 402 of the other party 410 (e.g., at operation 322) and, as such, each device may continue with the remainder of the trust evaluation process (e.g., operations 324-332).

In the mutual exchange embodiment shown here, the permission tokens 402 are not shared unless both are valid, ensuring a valid mutual exchange, quid pro quo, and thereby allowing either party 410A, 410B to submit a trust evaluation of the other party 410B, 410A, respectively. The transaction ID 404 allows the P2P evaluation engine 120 to link the two parties 410 in the mutual transaction, thereby identifying which party 410 the other is permissioning to have their permission token 402.

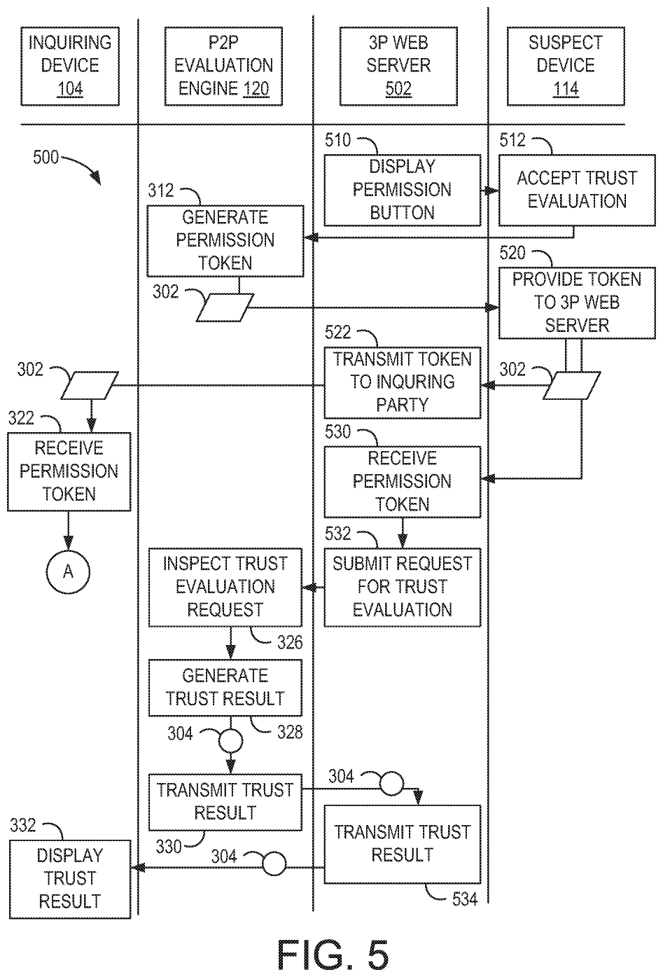

FIG. 5 is a swim lane diagram of an example method 500 for trust evaluation of the suspect party 112 by the P2P evaluation system 100 involving a third-party (3P) web server 502. The 3P web server 502 may be similar to the third-party server 130. In some embodiments, the 3P web server 502 may be, for example, an online e-commerce site (e.g., Amazon.com), an online classified advertisements site (e.g., Craigslist), a merchant site (e.g., BMW.com), escrow companies and their web sites, or an online auction site (e.g., eBay). In the example embodiment, the 3P web server 502 presents online content (e.g., a web page) to the suspect party 112 at operation 510. The online content may be, for example, an information page presenting information about a product or service offered for sale by the inquiring party 102. The online content includes a button or other clickable link that allows the suspect party 112 to permission the inquiring party 102, or the 3P web server 502, to perform a trust evaluation of the suspect party 112. At operation 512, the suspect party 112 accepts the trust evaluation (e.g., clicks on the button or link). This acceptance at operation 512 initiates communication to the P2P evaluation engine 120 to generate the permission token 302 at operation 312 (e.g., as described above with respect to FIG. 3). The P2P evaluation engine 120 transmits the permission token 302 back to the suspect device 114.

In one example embodiment, the permission token 302 is provided back to the inquiring device 104. More specifically, at operation 520, the suspect device 114 provides the permission token 302 to the 3P web server 502. The 3P web server 502 tracks which inquiring party 102 or inquiring device 104 is associated with the particular online content (e.g., the particular merchant or seller). As such, at operation 522, the 3P web server 502 identifies the inquiring party 102 and transmits the permission token 302 to the inquiring device 104. The inquiring device 104 receives the permission token 302 at operation 322 and may proceed with requesting a trust evaluation of the suspect party 112 (e.g., as described above with respect to operations 324-332).

In another example embodiment, the 3P web server 502 acts as the inquiring party for purposes of performing the trust evaluation. More specifically, at operation 520, the suspect device 114 transmits the permission token 302 to the 3P web server 502. At operation 530, the 3P web server 502 receives the permission token 302, and at operation 532, the 3P web server 502 submits a request for trust evaluation of the suspect party 112 to the P2P evaluation engine 120, the request including the permission token 302. In some embodiments, operation 532 may be similar to operation 324. At operations 326, 328, and 330, the P2P evaluation engine 120 evaluates the request, generates the trust result 304 for the suspect party 112, and transmits the trust result 304 back to the inquiring party (e.g., in this case, the 3P web server 502). At operation 534, the 3P web server 502 transmits the trust result 304 to the inquiring party device 104 for display to the inquiring party 102 at operation 332. In some embodiments, the P2P evaluation engine 120 may monitor the trust value over time (e.g., when there is a long term relationship between the inquiring party and the suspect party, or during the trust result duration).

This method 500 allows the P2P evaluation system 100 to integrate with a third-party system such as the 3P web server 502 while still maintaining many of the same benefits. The 3P web server 502 acts as the link between the inquiring party 102 and the suspect party 112. In some embodiments, the 3P web server 502 acts as a proxy inquiring party and passes the trust result 304 to the underlying inquiring party 102.

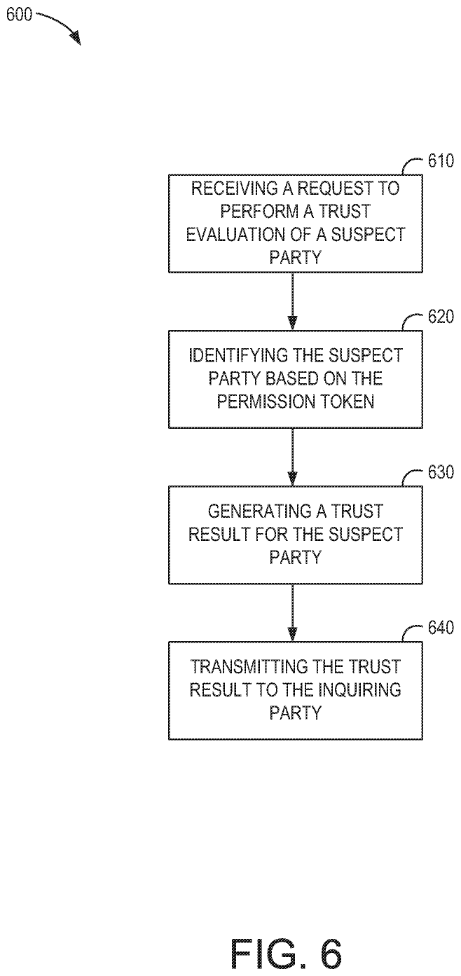

FIG. 6 illustrates an example computer-implemented method 600 for providing a trust evaluation of the suspect party 112 to the inquiring party 102. The computer-implemented method 600, hereafter referred to as “the method 600,” is performed by a computing device comprising at least one hardware processor and a memory. In an example embodiment, the method 600 includes receiving, from a second computing device of an inquiring party, a request to perform a trust evaluation of a suspect party, the request including a permission token, the suspect party being targeted for trust evaluation by the inquiring party (see operation 610). The method 600 also includes identifying the suspect party based on the permission token (see operation 620). The method 600 further includes generating a trust result for the suspect party based on financial data associated with the suspect party, the trust result indicating a level of trustworthiness assessed to the suspect party (see operation 630). The method 600 also includes transmitting the trust result for display to the inquiring party (see operation 640).

In some embodiments, the method 600 includes receiving, from a first computing device of the suspect party, a request to generate the permission token; generating a unique identifier for the permission token; and transmitting the permission token to the first computing device, the permission token being sharable between the first computing device and the second computing device to permission trust evaluation of the suspect party by the inquiring party. In some embodiments, the method 600 further includes transmitting, by the first computing device, the request to generate the permission token; receiving, at the first computing device, the permission token; and transmitting the permission token from the first computing device to the second computing device, thereby permissioning the second computing device to submit the request to perform the trust evaluation of the suspect party. In some embodiments, the first computing device includes a proximity-based wireless interface, and transmitting the permission token further includes transmitting the permission token to the second computing device using the proximity-based wireless interface.

In some embodiments, the permission token excludes personally identifiable information of the suspect party. In some embodiments, a third-party computing device presents a content item including an activation link selectable by the suspect party to generate the permission token, and the method 600 further includes receiving an indication that the suspect party has activated the activation link; in response to receiving the indication, generating the permission token; and transmitting permission token to the first computing device.

In some embodiments, the method 600 further includes identifying expiration data for the permission token, the expiration data indicating when the permission token expires, and receiving the request to perform the trust evaluation further includes comparing the expiration data of the permission token to a current time and rejecting the request to perform the trust evaluation if the permission token has expired based on the comparing.

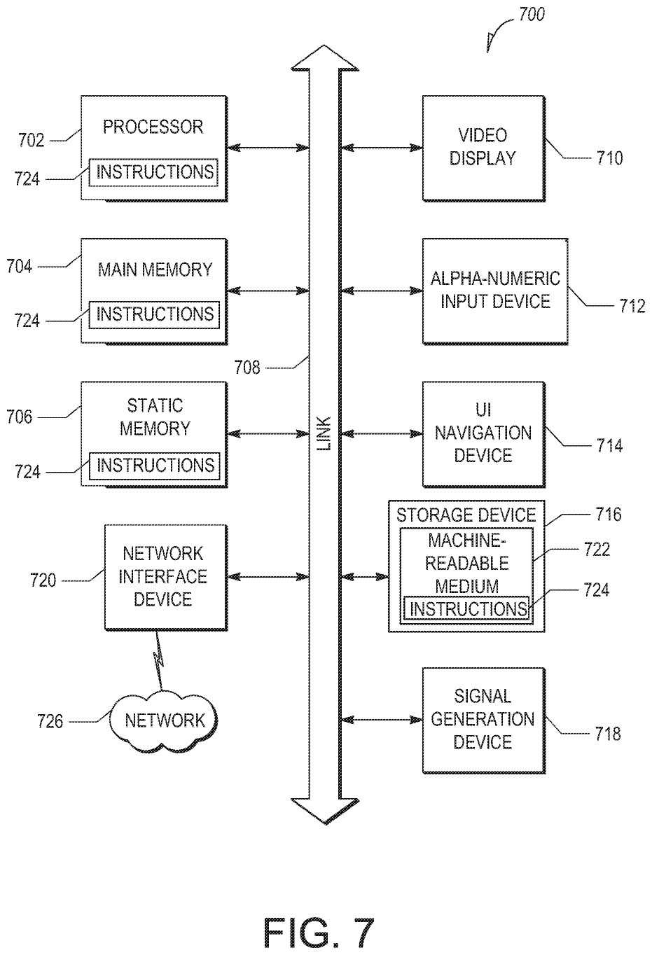

FIG. 7 is a block diagram illustrating a machine in the example form of a computer system 700, within which a set or sequence of instructions can be executed to cause the machine to perform any one of the methodologies discussed herein, according to an example embodiment. In alternative embodiments, the machine operates as a standalone device or can be connected (e.g., networked) to other machines. In a networked deployment, the machine can operate in the capacity of either a server or a client machine in server-client network environments, or it can act as a peer machine in peer-to-peer (or distributed) network environments. The machine can be a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 can further include a video display unit 710, an alphanumeric input device 712 (e.g., a keyboard), and a user interface (UI) navigation device 714 (e.g., a mouse). In one embodiment, the video display unit 710, alphanumeric input device 712, and UI navigation device 714 are incorporated into a touch-screen display. The computer system 700 can additionally include a storage device 716 (e.g., a drive unit), a signal generation device 718 (e.g., a speaker), a network interface device 720, and one or more sensors (not shown), such as a global positioning system (GPS) sensor, compass, accelerometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 can also reside, completely or at least partially, within the main memory 704, within the static memory 706, and/or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” can include a single medium or multiple media (e.g., a centralized or distributed database, and/or associated caches and servers) that store the one or more instructions 724. The term “machine-readable medium” shall also be taken to include any tangible medium that is capable of storing, encoding, or carrying instructions (e.g., instructions 724) for execution by the machine and that cause the machine to perform any one or more of the methodologies of the present disclosure or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 can further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone service (POTS) networks, and wireless data networks (e.g., Wi-Fi, 3G, and 6G LTE/LTE-A or WiMAX networks). The term “transmission medium” shall be taken to include any intangible medium that is capable of storing, encoding, or carrying instructions for execution by the machine, and includes digital or analog communications signals or other intangible media to facilitate communication of such software.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features may be grouped together to streamline the disclosure. However, the claims may not set forth every feature disclosed herein as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

1. A system for performing trust evaluations of a suspect party using a permission token passed between a first computing device of the suspect party and at least one inquiring party computing device via a proximity-based wireless interface, the system comprising:
at least one hardware processor in communication with the first computing device, a first inquiring party computing device, and a second inquiring party computing device; and
a memory storing instructions that, when executed by the at least one hardware processor, cause the at least one hardware processor to perform operations comprising:
sending the permission token to the first computing device of the suspect party, wherein the permission token comprises data indicating the suspect party;
receiving, from the first inquiring party computing device, a request to perform a first trust evaluation of the suspect party; the request including the permission token and metric data describing at least an amount of a prospective transaction with the suspect party and a duration of the prospective transaction with the suspect party;
determining that a use counter associated with the permission token indicates less than a maximum use number for the permission token;
identifying the suspect party based on the permission token;
generating a trust result for the suspect party based on financial data associated with the suspect party, the trust result indicating an assessed level of trustworthiness of the suspect party, the generating based at least in part on the metric data received from the first inquiring party computing device;
incrementing the use counter associated with the permission token; and
transmitting the trust result to the first inquiring party computing device;
receiving, from the second inquiring party computing device, a request to perform a second trust evaluation of the suspect party, the request including the permission token;
determining that the use counter associated with the permission token indicates less than the maximum use number for the permission token; and
transmitting a second trust result to the second inquiring party computing device.

2. The system of claim 1, wherein the operations further comprise:
receiving, from the first computing device of the suspect party, a request to generate the permission token, the permission token being sharable between the first computing device of the suspect party and the first inquiring party computing device to permission the first trust evaluation of the suspect party; and
generating a unique identifier for the permission token.

3. The system of claim 2, further comprising:
the first computing device of the suspect party, the first computing device of the suspect party being configured to perform operations comprising:
transmitting, to the at least one hardware processor, the request to generate the permission token;
receiving the permission token from the at least one hardware processor; and
transmitting the pet mission token to the first inquiring party computing device, thereby permissioning the first inquiring party computing device to submit the request to perform the first trust evaluation of the suspect party.

4. The system of claim 3, wherein the first computing device of the suspect party includes a proximity-based wireless interface, and wherein transmitting the permission token to the first inquiring party computing device further includes transmitting the permission token to the first inquiring party computing device using the proximity-based wireless interface.

5. The system of claim 1, wherein the permission token excludes personally identifiable information of the suspect party.

6. The system of claim 1, wherein the at least one hardware processor is further in communication with a third-party computing device, the third-party computing device presenting a content item including an activation link selectable by the suspect party to generate the permission token, wherein the operations further comprise:
receiving, from one of the third-party computing device and the first computing device of the suspect party, an indication that the suspect party has activated the activation link;
in response to receiving the indication, generating the permission token; and
transmitting the permission token to the first computing device of the suspect party.

7. The system of claim 1, wherein the operations further comprise:
identifying expiration data of the permission token, the expiration data indicating when the permission token expires,
wherein receiving the request to perform the first trust evaluation further includes:
comparing the expiration data of the permission token to a current time; and
rejecting the request to perform the first trust evaluation if the permission token has expired based on the comparing.

8. A computer-implemented method for performing trust evaluations of a suspect party using a permission token passed between a first computing device of the suspect party and at least one inquiring party second computing device via a proximity-based wireless interface, the method comprising:
sending the permission token to the first computing device of the suspect party, wherein the permission token comprises data indicating the suspect party;
receiving, from a first inquiring party computing device, a request to perform a first trust evaluation of the suspect party, the request including the permission token;
determining that a use counter associated with the permission token indicates less than a maximum use number for the permission token and metric data describing at least an amount of a prospective transaction with the suspect party and a duration of the prospective transaction with the suspect party;
identifying the suspect party based on the pet mission token;
generating a trust result for the suspect party based on financial data associated with the suspect party, the trust result indicating an assessed level of trustworthiness of the suspect party, the generating based at least in part on the metric data received from the first inquiring party computing device;
incrementing the use counter associated with the permission token; and
transmitting the trust result to the first inquiring party computing device;
receiving, from a second inquiring party computing device, a second request to perform a second trust evaluation of the suspect party, the second request including the permission token;
determining that the use counter associated with the permission token indicates less than the maximum use number for the permission token; and
transmitting a second trust result to the second inquiring party computing device.

9. The computer-implemented method of claim 8, further comprising:
receiving, from a first computing device of the suspect party, a request to generate the permission token; and
generating a unique identifier for the permission token,
the permission token being sharable between the first computing device of the suspect party and the first inquiring party computing device to permission the first trust evaluation of the suspect party by the inquiring party.

10. The computer-implemented method of claim 9, further comprising:
transmitting, by the first computing device, the request to generate the permission token;
receiving, at the first computing device, the permission token; and
transmitting the permission token from the first computing device to the first inquiring party computing device, thereby permissioning the first inquiring party computing device to submit the request to perform the first trust evaluation of the suspect party.

11. The computer-implemented method of claim 10, wherein the first computing device of the suspect party includes a proximity-based wireless interface, wherein transmitting the permission token to the first inquiring party computing device further includes transmitting the permission token to the first inquiring party computing device using the proximity-based wireless interface.

12. The computer-implemented method of claim 8, wherein the permission token excludes personally identifiable information of the suspect party.

13. The computer-implemented method of claim 8, wherein a third-party computing device presents a content item including an activation link selectable by the suspect party to generate the permission token, the method further comprising:
receiving, from one of the third-party computing device and a first computing device of the suspect party, an indication that the suspect party has activated the activation link;
in response to receiving the indication, generating the permission token; and
transmitting the permission token to the first computing device of the suspect party.

14. The computer-implemented method of claim 8, further comprising:
identifying expiration data of the permission token, the expiration data indicating when the permission token expires,
wherein receiving the request to perform the first trust evaluation further includes:
comparing the expiration data of the permission token to a current time; and
rejecting the request to perform the first trust evaluation if the permission token has expired based on the comparing.

15. A non-transitory computer-readable storage medium, the computer-readable storage medium including instructions that when executed by a computer, cause the computer to perform operations comprising:
sending a permission token to a first computing device of a suspect party, the permission token for passing from the first computing device of the suspect party to at least one inquiring party computing devices via a proximity-based wireless interface;
receiving, from a first inquiring party computing device, a request to perform a first trust evaluation of the suspect party, the request including permission token;
determining that a use counter associated with the permission token indicates less than a maximum use number for the permission token and metric data describing at least an amount of a prospective transaction with the suspect party and a duration of the prospective transaction with the suspect party;
identifying the suspect party based on the permission token;
generating a trust result for the suspect party based on financial data associated with the suspect party, the trust result indicating an assessed level of trustworthiness of the suspect party, the generating based at least in part on the metric data received from the first inquiring party computing device;
incrementing the use counter associated with the permission token; and
transmitting the trust result to the first inquiring party computing device;
receiving, from a second inquiring party computing device, a request to perform a second trust evaluation of the suspect party, the request including the permission token;
determining that the use counter associated with the permission token indicates less than the maximum use number for the permission token; and
transmitting a second trust result to the second inquiring party computing device.

16. The non-transitory computer-readable storage medium of claim 15, wherein the operations further comprise:
receiving, from a first computing device of the suspect party, a request to generate the permission token; and
generating a unique identifier for the permission token.

17. The non-transitory computer-readable storage medium of claim 16, wherein the operations further comprise:
transmitting, by the first computing device of the suspect party, the request to generate the permission token;
receiving, at the first computing device of the suspect party, the permission token; and
transmitting the permission token from the first computing device of the suspect party to the first inquiring party computing device, thereby permissioning the first inquiring party computing device to submit the request to perform the first trust evaluation of the suspect party.

18. The non-transitory computer-readable storage medium of claim 17, wherein the first computing device of the suspect party includes a proximity-based wireless interface, and wherein transmitting the permission token to the first inquiring party, computing device further includes transmitting the permission token to the first inquiring party computing device using the proximity-based wireless interface.

19. The non-transitory computer-readable storage medium of claim 15, wherein a third-party computing device presents a content item including an activation link selectable by the suspect party to generate the permission token, wherein the operations further comprise:
receiving, from one of the third-party computing device and a first computing device of the suspect party, an indication that the suspect party has activated the activation link;
in response to receiving the indication, generating the permission token; and
transmitting the permission token to the first computing device of the suspect party.

20. The non-transitory computer-readable storage medium of claim 15, wherein the operations further comprise:
identifying expiration data of the permission token, the expiration data indicating when the permission token expires,
wherein receiving the request to perform the first trust evaluation further includes:
comparing the expiration data of the permission token to a current time; and
rejecting the request to perform the first trust evaluation if the permission token has expired based on the comparing.
